(19) United States
(12) Patent Application Publication
(10) Pub. No.: US 2018/0202923 A1
(43) Pub. Date: Jul. 19, 2018

(54) Gas Detection Device and Gas Detection Method

(71) Applicant: Konica Minolta, Inc., Tokyo (JP)

(72) Inventors: Masashi KAGEYAMA, Hachioji-shi, Tokyo (JP); Hikaru NAGASAWA, Hanno-shi, Saitama (JP); Ryouta ISHIKAWA, Hino-shi, Tokyo (JP); Kyuichiro IMADE, Mitaka-shi, Tokyo (JP)

(73) Assignee: Konica Minolta, Inc., Tokyo (JP)

(21) Appl. No.: 15/742,316

(22) PCT Filed: Jul. 11, 2016
(86) PCT No.: PCT/JP2016/070480

§ 371 Date: Jan. 5, 2018

(30) Foreign Application Priority Data
Jul. 17, 2015 (JP) 2015-143044

(51) Int. Cl. G01N 21/3504; G01N 21/359; G01N 21/39; G01J 3/42

(52) U.S. Cl. CPC G01N 21/3504; G01N 21/359; G01N 2021/396; G01J 3/42; G01N 21/39

(57) ABSTRACT

In a gas detection device and a gas detection method of the present invention, detection target gas is detected on the basis of reflected light of detection light (sensing light) frequency-modulated with respect to a center frequency and a distance to an object that generates the reflected light is measured. In the gas detection, an output signal of a light reception unit for receiving the reflected light is subjected to phase-sensitive detection. A synchronous detection timing of this phase-sensitive detection is adjusted on the basis of the measured distance to the object.

### TECHNICAL FIELD

The present invention relates to a gas detection device and a gas detection method for detecting detection target gas.

### BACKGROUND ART

For example, in the case of leakage of gas such as flammable gas, toxic gas and organic solvent steam from a pipe, a tank or the like, such a situation needs to be promptly dealt with. Thus, devices for detecting gas have been and are being studied and developed. A technology utilizing an absorption line of a light absorption spectrum of gas is known as one of technologies for detecting gas. This technology utilizes a property that the attenuation of light having a frequency (wavelength) of an absorption line is proportional to a gas concentration. In principle, laser light having the frequency of the absorption line is irradiated to gas, the attenuation of the laser light passed through the gas is measured and the gas concentration is measured by multiplying this measurement result by a conversion coefficient set in advance. Measurement methods based on this principle typically include a two-wavelength differential method and a frequency modulation method (2f detection method) (see, for example, patent literature 1).

In this frequency modulation method (2f detection method), laser light having a frequency fc of an absorption line is frequency-modulated at a modulation frequency fm, and the laser light frequency-modulated at the modulation frequency fm using this frequency fc of the absorption line as a center frequency fc is irradiated to gas and received by a light reception unit after passing through the gas. Here, a light absorption spectrum of the gas has a line-symmetrical profile with respect to the frequency fc of the absorption line such as a quadratic function profile in a range near the frequency of the absorption line. Thus, an output signal of the light reception unit includes not only a component of the modulation frequency fm, but also a component of 2fm (second harmonic). This component of the second harmonic 2fm is subjected to phase-sensitive detection, and a gas concentration is obtained on the basis of this component of the second harmonic 2fm subjected to phase-sensitive detection. Note that the influence of a received light intensity variation (noise) due to factors excluding the gas can be reduced by subjecting the component of the modulation frequency fm also to phase-sensitive detection simultaneously with the phase-sensitive detection of the second harmonic 2fm and normalizing the amount of the received light (by obtaining a ratio of the component of the second harmonic 2fm to the component of the modulation frequency fm).

A gas concentration measurement device disclosed, for example, in patent literature 2 is known as one of devices using such a frequency modulation method. The gas concentration measurement device disclosed in this patent literature 2 includes a sensing light radiation unit for radiating sensing light, a light reception unit for receiving reflected light reflected from an object when the sensing light is irradiated to the object, a column density measurement unit for measuring a column density of the gas to be detected, an optical path length measurement unit for measuring an optical path length of the sensing light from the sensing light radiation unit to the object and a concentration calculation unit for calculating a concentration of the gas to be detected on the basis of the column density and the optical path length. Then, the concentration calculation unit calculates an average concentration of the gas to be detected along an optical path of the sensing light by dividing the column density by the optical path length.

In the frequency modulation method (2f detection method), the phase-sensitive detection is performed using a synchronization signal synchronized with the modulation frequency. Since the propagation of the frequency-modulated laser light from the radiation to the reception takes time, a synchronous detection timing (phase) of the synchronization signal needs to be corrected using the propagation time. However, since by which object the laser light is reflected to return differs depending on a detection target in each detection, the propagation time cannot be uniformly set. Particularly, if the modulation frequency is set at a higher frequency for faster detection, a phase delay of the synchronization signal caused by the propagation time increases and the influence of the propagation time is large. For example, when the phase delay is about 1° at a relatively low modulation frequency (e.g. 10 kHz) between equidistant objects, the phase delay is about 10° if the modulation frequency is set ten times as high (100 kHz in the above example).

On the other hand, although a distance measurement is conducted in the above patent literature 2, this distance measurement is conducted to obtain the average concentration from the column density (concentration thickness product). The correction of the synchronous detection timing is neither described nor indicated in the above patent literature 2.

### CITATION LIST

### Patent Literature

Patent literature 1: Japanese Unexamined Patent Publication No. H7-151681

Patent literature 2: Japanese Unexamined Patent Publication No. 2014-55858

### SUMMARY OF INVENTION

The present invention was developed in view of the above situation and aims to provide a gas detection device and a gas detection method capable of more accurately detecting gas by adjusting a synchronous detection timing.

In a gas detection device and a gas detection method according to the present invention, detection target gas is detected on the basis of reflected light of detection light (sensing light) frequency-modulated with respect to a center frequency and a distance to an object that generates the reflected light is measured. In the gas detection, an output signal of a light reception unit for receiving the reflected light is subjected to phase-sensitive detection. A synchronous detection timing of this phase-sensitive detection is adjusted on the basis of the measured distance to the object. Thus, the gas can be more accurately detected by adjusting the synchronous detection timing.

The above and other objects, features and advantages of the present invention will become apparent from the following detailed description and the accompanying drawings.

### BRIEF DESCRIPTION OF DRAWINGS

FIG. 1 is a block diagram showing the configuration of a gas detection device in an embodiment,

FIG. 2 is a block diagram showing the configuration of a first phase-sensitive detection unit in the gas detection device,

FIG. 3 is a block diagram showing the configuration of a second phase-sensitive detection unit in the gas detection device,

FIG. 4 is a graph showing a frequency modulation method (2f detection method),

FIG. 5 is a chart showing a detection synchronous timing of a synchronization signal in response to an output signal in the first and second phase-sensitive detection units,

FIG. 6 is a flow chart showing the operation of the gas detection device, and

FIG. 7 is a chart showing the adjustment of the detection synchronous timing of the gas detection device.

### DESCRIPTION OF EMBODIMENT

Hereinafter, one embodiment according to the present invention is described with reference to the drawings. Note that components denoted by the same reference signs have the same configurations in each figure and the description thereof is omitted as appropriate.

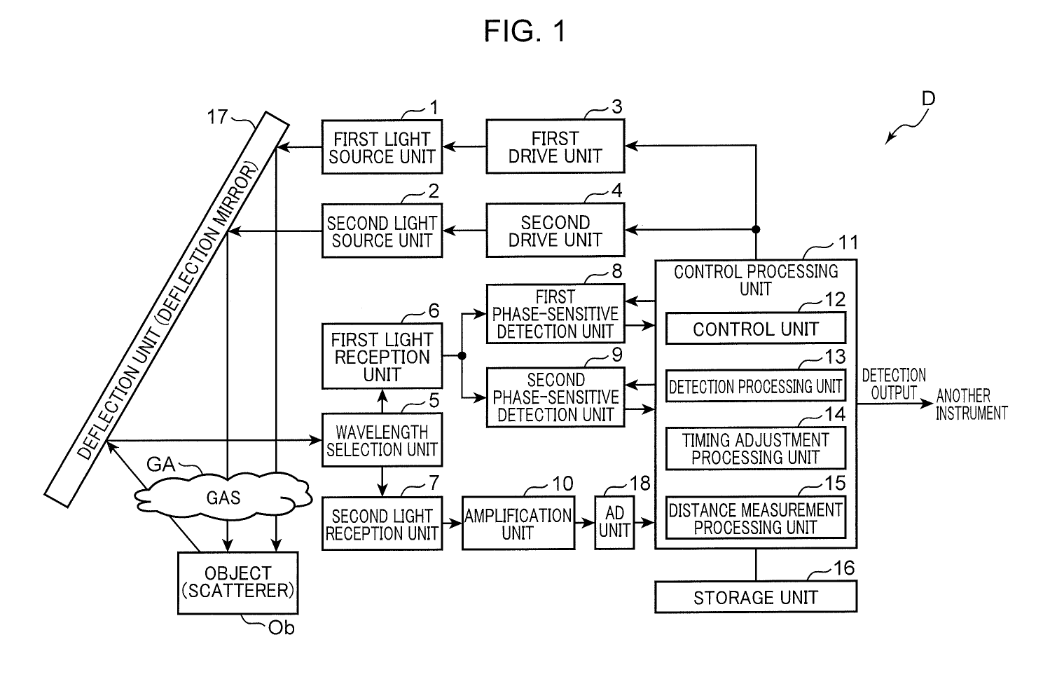

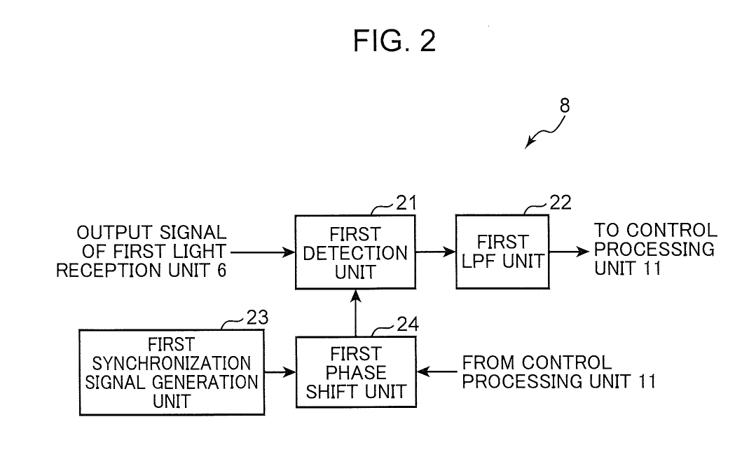

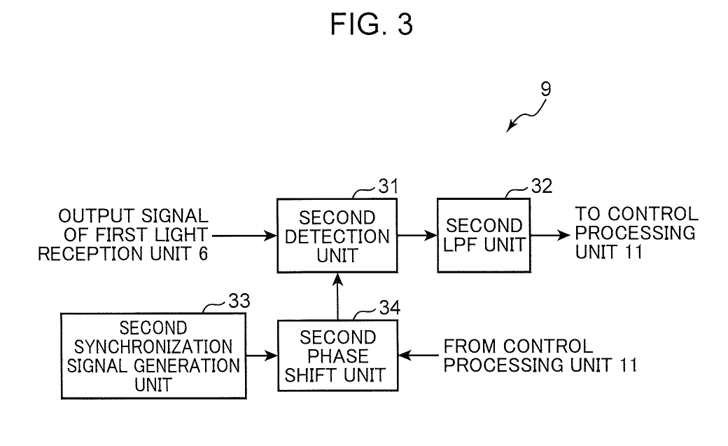

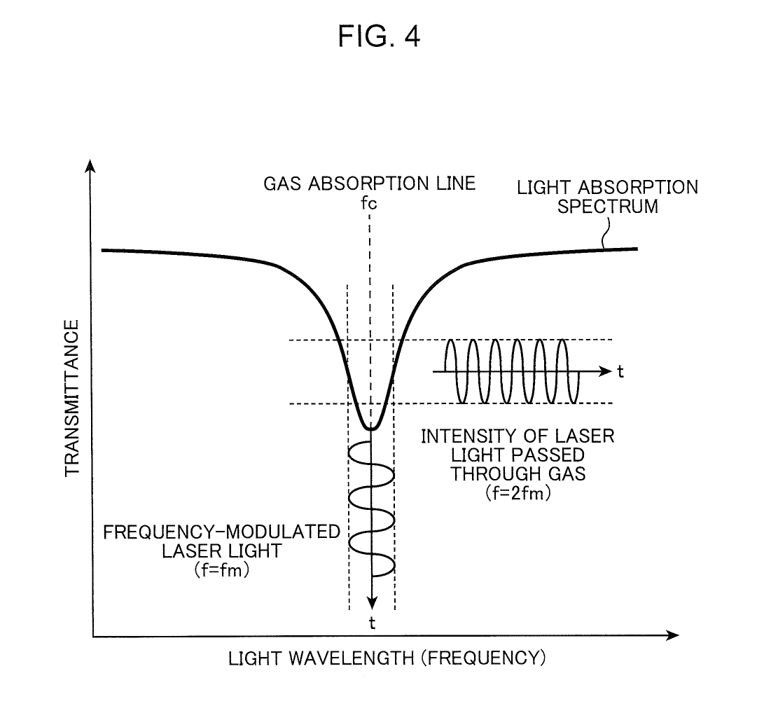

FIG. 1 is a block diagram showing the configuration of a gas detection device in the embodiment. FIG. 2 is a block diagram showing the configuration of a first phase-sensitive detection unit in the gas detection device. FIG. 3 is a block diagram showing the configuration of a second phase-sensitive detection unit in the gas detection device. FIG. 4 is a graph showing a frequency modulation method (2f detection method).

The gas detection device in the embodiment is a device for detecting detection target gas GA by a so-called frequency modulation method (2f detection method) and includes, for example, a gas detection unit for irradiating detection light Lc frequency-modulated at a predetermined modulation frequency fm using a predetermined frequency fc as a center frequency fc, receiving reflected light (return light) Lcr of this detection light Lc and detecting the detection target gas GA on the basis of this received reflected light Lcr, and a distance measurement unit for measuring a distance Ds to an object Ob to which the detection light Lc is irradiated and which generates the reflected light Lcr based on the detection light Lc.

More specifically, such a gas detection device D includes a first light source unit 1, a second light source unit 2, a first drive unit 3, a second drive unit 4, a wavelength selection unit 5, a first light reception unit 6, a second light reception unit 7, a first phase-sensitive detection unit 8, a second phase-sensitive detection unit 9, an amplification unit 10, a control processing unit 11, a storage unit 16, a deflection unit 17, an analog-digital conversion unit (AD unit) 18, for example, as shown in FIG. 1.

The first light source unit 1 is a device connected to the first drive unit 3 and configured to irradiate the detection light Lc frequency-modulated at the predetermined modulation frequency fm using the predetermined first frequency fc as the center frequency fc in the form of continuous light (CW light) for the detection of the detection target gas GA and includes, for example, a wavelength variable semiconductor laser or the like that can emit laser light while changing a wavelength. The modulation frequency fm is appropriately set, e.g. at 10 kHz, 50 kHz or 100 kHz. The first frequency (center frequency) fc is a frequency of a predetermined absorption line in a light absorption spectrum of the detection target gas GA and appropriately set according to the type of the detection target gas GA. For example if the detection target gas GA is methane, the first frequency (center frequency) fc is set at a frequency of a predetermined absorption line in a light absorption spectrum of methane. Although there are a plurality of absorption lines in the light absorption spectrum of methane, an absorption line having a wavelength of 1653 nm, which is an R(3) line, or an absorption line having a wavelength of 1651 nm, which is a R(4) line, at which methane is most strongly absorbed, is employed in this embodiment and the first frequency (center frequency) fc is a frequency equivalent to the wavelength of 1653 nm or the wavelength of 1651 nm.

Note that the detection target gas GA is not limited to methane and may be various types of gas as shown in Table 1. Gas types and wavelengths (μm) of absorption lines thereof are shown as examples of the detection target gas GA.

TABLE 1

| Gas Type | Wavelength (μm) |
|---|---|
| H₂O | 1.365 |
| CO | 1.567 |
| CO₂ | 1.573 |
| | 2.004 |
| NH₃ | 1.544 |
| C₂H₂ | 1.53 |
| H₂S | 1.578 |
| N₂O | 1.954 |
| NO | 1.795 |
| HCl | 1.742 |

The first drive unit 3 is a device connected to the control processing unit 11 and configured to drive the first light source unit 1 to irradiate the detection light Lc frequency-modulated at the predetermined modulation frequency fm using the predetermined first frequency as the center frequency fc in the form of continuous light in accordance with a control of the control processing unit 11. For example, the first drive unit 3 causes the first light source unit 1 to irradiate the detection light Lc by supplying a drive current modulated for the frequency modulation of the detection light LC at the modulation frequency fm to the variable wavelength semiconductor laser in accordance with the control of the control processing unit 11.

The second light source unit 2 is a device connected to the second drive unit 4 and configured to irradiate predetermined distance measurement light Ld having a second frequency fx (≠fc) different from the first frequency fc of the detection light Lc in the form of pulsed light for distance measurement and includes, for example, a semiconductor laser or the like. The second frequency fd is appropriately set to be different from the first frequency fc of the detection light Lc. Since the first frequency fc of the detection light Lc is the frequency of the absorption line in the detection target gas GA in this embodiment, the second frequency fd of the distance measurement light Ld is a frequency other than the frequency fc of the absorption line in the detection target gas GA. As an example, since the first frequency fc of the detection light Lc is the frequency equivalent to the wavelength of 651 nm or the wavelength of 1653 nm in this embodiment, the second frequency fd is a frequency equivalent to any one of wavelengths (e.g. 800 nm, 870 nm, 905 nm, 1000 nm) in a wavelength range of 800 nm to 1000 nm. Note that the second frequency fd of the distance measurement light Ld is preferably a frequency other than frequencies of absorption lines in other types of gas different from the detection target gas GA supposed to be present in a space where the detection target gas GA is present.

The second drive unit 4 is a device connected to the control processing unit 11 and configured to drive the second light source unit 2 to irradiate the predetermined distance measurement light Ld having the second frequency fx (≠fc) in the form of pulsed light in accordance with the control of the control processing unit 11. For example, the second drive unit 4 causes the second light source unit 2 to irradiate the distance measurement light Ld by supplying a pulsed drive current to the semiconductor laser in accordance with the control of the control processing unit 11.

The deflection unit 17 is a device on which the detection light Lc emitted from the first light source unit 1 is incident and which irradiates the detection light Lc successively in a plurality of mutually different directions for detection at a plurality of detection points. In this embodiment, the distance measurement light Ld emitted from the second light source unit 2 is incident on the deflection unit 17 so as to be able to measure the distance Ds to the object Ob, to which the detection light Lc is irradiated and which generates the reflected light Lcr based on the detection light Lc, and the deflection unit 17 irradiates the distance measurement light Ld successively in the same directions as the detection light Lc. In this embodiment, first reflected light (return light) generated on the basis of the detection light Lc by the object Ob irradiated with the detection light Lc and second reflected light (return light) Ldr generated on the basis of the distance measurement light Ld by the object Ob irradiated with the distance measurement light Ld are also incident on the deflection unit 17, and the deflection unit 17 deflects these first reflected light Lcr and second reflected light Ldr to the wavelength selection unit 5. Such a deflection unit 17 includes, for example, a deflection mirror (reflection mirror) in the form of a flat plate and an actuator such as a motor for rotating the deflection mirror about a predetermined axis, and successively changes a first incident angle of the detection light Lc emitted from the first light source unit 1 and a second incident angle of the distance measurement light Ld emitted from the second light source unit 2 by rotating the deflection mirror about the predetermined axis by the actuator. This causes the deflection unit 17 to successively irradiate each of the detection light Lc and the distance measurement light Ld in the plurality of mutually different directions. Note that although the deflection mirror is perpendicular to the plane of FIG. 1 in an example shown in FIG. 1, the deflection mirror may be inclined (may be inclined with respect to a normal direction to the plane of FIG. 1).

In this embodiment, a first optical axis of the detection light Lc and a second optical axis of the distance measurement light Ld are parallel to each other as shown in FIG. 1. Specifically, the first and second light source units 1, 2 are so arranged with respect to the deflection unit 17 that the first optical axis of the detection light Lc and the second optical axis of the distance measurement light Ld are parallel to each other (the first incident angle of the detection light Lc on the deflection mirror and the second incident angle of the distance measurement light Ld on the deflection mirror are equal to each other). The first optical axis of the detection light Lc and the second optical axis of the distance measurement light Ld are preferably proximately parallel to each other, more preferably most proximately parallel to each other without overlapping each other to more suitably measure the distance Ds to the object Ob that generates the reflected light Lcr.

The wavelength selection unit 5 is a device on which the first reflected light Lcr of the detection light Lc and the second reflected light Ldr of the distance measurement light Ld are incident and which substantially separately emits the first reflected light Lcr of the detection light Lc and the second reflected light Ldr of the distance measurement light Ld. The first reflected light Lcr of the detection light Lc emitted from the wavelength selection unit 5 is incident on the first light reception unit 6, and the second reflected light Ldr of the distance measurement light Ld emitted from the wavelength selection unit 5 is incident on the second light reception unit 7. Such a wavelength selection unit 5 includes a dichroic mirror for reflecting the first reflected light Lcr of the detection light Lc emitted from the wavelength selection unit 5 toward the first light reception unit 6 and transmitting the second reflected light Ldr of the distance measurement light Ld emitted from the wavelength selection unit 5 so that the second reflected light Ldr is received by the second light reception unit 7, and the like. Further, the wavelength selection unit 5 includes, for example, a half mirror for branching incident light into two, a first band-pass filter on which one part branched (reflected) by the half mirror and which transmits a wavelength band including the first reflected light Lcr of the detection light Lc and a second band-pass filter on which one part branched (transmitted) by the half mirror is incident and which transmits a wavelength band including the second reflected light Ldr of the distance measurement light Ld, the light emitted from the first band-pass filter (mainly including the first reflected light Lcr of the detection light Lc) is incident on the first light reception unit 6, and the light emitted from the second band-pass filter (mainly including the second reflected light Ldr of the distance measurement light Ld) is incident on the second light reception unit 7.

The first light reception unit 6 is a device connected to each of the first and second phase-sensitive detection units 8, 9 and configured to receive and photoelectrically convert the first reflected light Lcr of the detection light Lc emitted from the wavelength selection unit 5, thereby outputting an electrical signal (first output signal) SG1 of a level corresponding to the light intensity of the first reflected light Lcr to each of the first and second phase-sensitive detection units 8, 9.

The second light reception unit 7 is a device connected to the amplification unit 10 and configured to receive and photoelectrically convert the second reflected light Ldr of the distance measurement light Ld emitted from the wavelength selection unit 5, thereby outputting an electrical signal (second output signal) SG2 of a level corresponding to the light intensity of the second reflected light Ldr to the amplification unit 10.

In this embodiment, a first light receiving sensitivity wavelength band of the first light reception unit 6 and a second light receiving sensitivity wavelength band of the second light reception unit 7 are different from each other by a predetermined sensitivity threshold value (e.g. 40%, 50% and 60% to maximum sensitivity). The first light receiving sensitivity wavelength band of the first light reception unit 6 and the second light receiving sensitivity wavelength band of the second light reception unit 7 may overlap each other by less than the predetermined sensitivity threshold value, but preferably such an overlapping part is absent and the two light receiving sensitivity wavelength bands are different from each other. More specifically, since the wavelength of the detection light Lc is 1651 nm or 1653 nm in this embodiment, the first light reception unit 6 includes an InGaAs (indium gallium arsenide) light receiving element (InGaAs photodiode) having superior light receiving sensitivity to a 1600 nm wavelength band. Since the wavelength of the distance measurement light Ld is any one of wavelengths in the wavelength range of 800 nm to 1000 nm, the second light reception unit 7 includes a Si (silicon) light receiving element (Si photodiode) having superior light receiving sensitivity to a 800 nm-1000 nm wavelength band. Because of high sensitivity, the second light reception unit 7 more preferably includes a Si avalanche photodiode.

The first phase-sensitive detection unit 8 is a device connected to the control processing unit 11 and configured to perform a phase-sensitive detection of the first output signal SG1 of the first light reception unit 6 on the basis of the modulation frequency fm at which the detection light Lc is frequency-modulated. The first phase-sensitive detection unit 8 outputs a phase-sensitive detection result (first phase-sensitive detection result) to the control processing unit 11. Such a first phase-sensitive detection unit 8 includes, for example, a first detection unit 21, a first low-pass filter unit (first LPF unit) 22, a first synchronization signal generation unit 23 and a first phase shift unit 24 as shown in FIG. 2.

The first synchronization signal generation unit 23 is a circuit connected to the first phase shift unit 24 and configured to generate a first synchronization signal SS1 in the form of a rectangular pulse having a duty ratio of 50% at the modulation frequency fm and includes, for example, an oscillator and the like. The first synchronization signal generation unit 23 outputs this generated first synchronization signal SS1 to the first phase shift unit 24.

The first phase shift unit 24 is a circuit connected to the first detection unit 21 and configured to change (advance or delay) the phase of the first synchronization signal SS1 of the first synchronization signal generation unit 23 in accordance with the control of the control processing unit 11 as described later and includes, for example, a phase shifter and the like. The first phase shift unit 24 outputs the first synchronization signal SS1 changed to a predetermined phase to the first detection unit 21.

The first detection unit 21 is a circuit connected to the first LPF unit 22 and configured to synchronously detect an output signal of the first light reception unit 6 input from the first light reception unit 6 on the basis of the first synchronization signal SS1 input from the first phase shift unit 24 and includes, for example, a multiplier and the like or a switching element and the like. A frequency component equal to the first synchronization signal SS1, i.e. the component of the modulation frequency fm is extracted from the output signal of the first light reception unit 6 by this synchronous detection. The first detection unit 21 outputs a synchronous detection result to the first LPF unit 22.

The first LPF unit 22 is a circuit connected to the control processing unit 11 and configured to filter the synchronous detection result input from the first detection unit 21 and cause only components equal to or below a predetermined cut-off frequency to pass. The first LPF unit 22 outputs this filtering result to the control processing unit 11 as a first phase-sensitive detection result of the first phase-sensitive detection unit 8.

The second phase-sensitive detection unit 9 is a device connected to the control processing unit 11 and configured to perform a phase-sensitive detection of the first output signal SG1 of the first light reception unit 6 on the basis of a frequency (second harmonic) 2fm, which is twice the modulation frequency fm at which the detection light Lc is frequency-modulated. The second phase-sensitive detection unit 9 outputs a phase-sensitive detection result (second phase-sensitive detection result) to the control processing unit 11. Such a second phase-sensitive detection unit 9 is basically similar to the first phase-sensitive detection unit 8 and includes, for example, a second detection unit 31, a second low-pass filter unit (second LPF unit) 32, a second synchronization signal generation unit 33 and a second phase shift unit 34 as shown in FIG. 3.

The second synchronization signal generation unit 33 is a circuit connected to the second phase shift unit 34 and configured to generate a second synchronization signal SS2 in the form of a rectangular pulse having a duty ratio of 50% at the frequency 2fm, which is twice the modulation frequency fm, and includes, for example, an oscillator and the like. The second synchronization signal generation unit 33 outputs this generated second synchronization signal SS2 to the second phase shift unit 34.

The second phase shift unit 34 is a circuit connected to the second detection unit 31 and configured to change (advance or delay) the phase of the second synchronization signal SS2 of the second synchronization signal generation unit 33 in accordance with the control of the control processing unit 11 as described later and includes, for example, a phase shifter and the like. The second phase shift unit 34 outputs the second synchronization signal SS2 changed to a predetermined phase to the second detection unit 31.

The second detection unit 31 is a circuit connected to the second LPF unit 32 and configured to synchronously detect the output signal of the first light reception unit 6 input from the first light reception unit 6 on the basis of the second synchronization signal SS2 input from the second phase shift unit 34 and includes, for example, a multiplier and the like or a switching element and the like. A frequency component equal to the second synchronization signal SS2, i.e. the component of the second harmonic 2fm, which is twice the modulation frequency fm, is extracted from the output signal of the first light reception unit 6 by this synchronous detection. The second detection unit 31 outputs a synchronous detection result to the second LPF unit 32.

The second LPF unit 32 is a circuit connected to the control processing unit 11 and configured to filter the synchronous detection result input from the second detection unit 31 and cause only components equal to or below a predetermined cut-off frequency to pass. The second LPF unit 32 outputs this filtering result to the control processing unit 11 as a second phase-sensitive detection result of the second phase-sensitive detection unit 9.

The amplification unit 10 is a circuit connected to the AD unit 18 and configured to amplify the second output signal SG2 of the second light reception unit 7 input from the second light reception unit 7. The amplification unit 10 outputs this amplified second output signal SG2 to the control processing unit 11 via the AD unit 18.

The AD unit 18 is a circuit connected to the control processing unit 11 and configured to convert the analog second output signal SG2 output from the amplification unit 10 into a digital second output signal and output this converted digital second output signal to the control processing unit 11.

The storage unit 16 is a circuit connected to the control processing unit 11 and configured to store various predetermined programs and various pieces of predetermined data in accordance with the control of the control processing unit 11. The various predetermined programs include control processing programs such as, for example, a control program for controlling each part of the gas detection device D according to a function of each part, a gas detection program for irradiating the detection light (sensing light) Lc frequency-modulated at the predetermined modulation frequency fm using the predetermined frequency fc as the center frequency fc, receiving the first reflected light Lcr of the detection light Lc and detecting the detection target gas GA on the basis of this received first reflected light Lcr, and a distance measuring program for measuring the distance Ds to the object Ob that is irradiated with the detection line Lc and generates the first reflected light Lcr based on the detection light Lc. The various pieces of predetermined data include data necessary in executing each of the above programs, data necessary in detecting the detection target gas GA and the like. The storage unit 16 includes, for example, a ROM (Read Only Memory), which is a nonvolatile storage element, and an EEPROM (Electrically Erasable Programmable Read Only Memory), which is a rewritable nonvolatile storage element, and the like. The storage unit 16 includes a RAM (Random Access Memory) or the like serving as a so-called working memory of the control processing unit 11 for storing data and the like generated during the execution of the predetermined program.

The control processing unit 11 is a circuit configured to control each part of the gas detection device D according to the function of each part and detect the detection target gas GA. The control processing unit 11 is, for example, configured to include a CPU (Central Processing Unit) and its peripheral circuits. The control processing unit 11 is functionally provided with a control unit 12, a detection processing unit 13, a timing adjustment processing unit 14 and a distance measurement processing unit 15 by executing the control processing program.

The control unit 12 controls each part of the gas detection device D according to the function of each part and the entire gas detection device D. For example, for detection at a plurality of detection points, the control unit 12 controls the deflection unit 17 to irradiate each of the detection light Lc and the distance measurement light Ld in a plurality of mutually different directions and to successively receive the first reflected light Lcr and the second reflected light Ldr by the wavelength selection unit 5. Further, for example, the control unit 12 controls the first light source unit 1 via the first drive unit 3 so that the detection light Lc frequency-modulated at the modulation frequency fm is irradiated in the form of CW light. Further, for example, the control unit 12 controls the second light source unit 2 via the second drive unit 4 so that the distance measurement light Ld is irradiated in the form of pulsed light.

The detection processing unit 13 detects the detection target gas GA on the basis of the first reflected light Lcr of the detection light Lc received by the first light reception unit 6. More specifically, the detection processing unit 13 detects the detection target gas GA utilizing a so-called frequency modulation method (2f detection method). As shown in FIG. 4, a light absorption spectrum of the gas has a line-symmetrical profile with respect to the frequency fc of the absorption line such as a quadratic function profile in a range near the frequency fc of the absorption line. Thus, as described above, if laser light frequency-modulated at the modulation frequency fm using the frequency fc of the absorption line as the center frequency fc is irradiated to the gas, the intensity of the laser light passed through the gas undergoes one-cycle oscillation by half-cycle oscillation on a wavelength side shorter than the center frequency fc, and undergoes one-cycle oscillation one more time by half-cycle oscillation on a wavelength side longer than the center frequency fc. As a result, the laser light passed through the gas includes an intensity component having a frequency (second harmonic) 2fm, which is twice the modulation frequency fm. Since the intensity of this component of the second harmonic 2fm is proportional to a gas concentration as understood from FIG. 4, the gas concentration can be measured by detecting this component of the second harmonic 2fm. By normalizing this component of the second harmonic 2fm by the component of the modulation frequency fm, a light receiving intensity variation (noise) caused by factors other than absorption by the detection target gas GA can be reduced. Thus, more specifically, the detection processing unit 13 detects the detection target gas on the basis of the first phase-sensitive detection result of the first phase-sensitive detection unit 8 representing the component of the modulation frequency fm and the second phase-sensitive detection result of the second phase-sensitive detection unit 9 representing the component of the second harmonic 2fm.

The detection processing unit 13 may detect the detection target gas GA by determining the presence or absence of the detection target gas GA, but preferably detects the detection target gas by obtaining the concentration thickness product in the detection target gas GA on the basis of the first reflected light Lcr received by the first light reception unit 6, i.e. the second phase-sensitive detection result of the second phase-sensitive detection unit 9. More specifically, a function expression, a look-up table or the like representing a correspondence relationship between a division result obtained by dividing the component of the second harmonic 2fm by the component of the modulation frequency fm and the concentration thickness product is obtained and stored in the storage unit 16, and the detection processing unit 13 detects the detection target gas GA by dividing the second phase-sensitive detection result of the second phase-sensitive detection unit 9 by the first phase-sensitive detection result of the first phase-sensitive detection unit 8 and converting this division result into the concentration thickness product using the function expression, the look-up table or the like.

Further preferably, since the distance Ds to the object Ob is obtained by the distance measurement processing unit 15 as described later, the detection processing unit 13 obtains the concentration thickness product as described above and detects the detection target gas GA by dividing the thus obtained concentration thickness product by the distance Ds measured by the distance measurement processing unit 15 to obtain an average gas concentration.

The timing adjustment processing unit 14 adjusts the synchronous detection timing of the phase-sensitive detection unit on the basis of the distance Ds to the object Ob obtained by the distance measurement processing unit 15. Since the phase-sensitive detection unit is composed of the first and second phase-sensitive detection units 8, 9 in this embodiment, the timing adjustment processing unit 14 adjusts the synchronous detection timing of each of the first and second phase-sensitive detection units 8, 9 on the basis of the distance Ds to the object Ob obtained by the distance measurement processing unit 15.

The distance measurement processing unit 15 obtains the distance Ds to the object Ob on the basis of an irradiation timing t1 of irradiating the distance measurement light Ld and a light reception timing of receiving the second reflected light Ldr of the distance measurement light Ld. More specifically, the distance measurement processing unit 15 calculates a propagation time τ (=t2−t1) until the distance measurement light Ld emitted from the second light source unit 2 becomes the second reflected light Ldr at the object Ob and this second reflected light Ldr is received by the second light reception unit 7 by subtracting the irradiation timing t1 from the light reception timing t2, and obtains the distance Ds from the gas detection device D to the object Ob by multiplying half the obtained propagation time τ by a propagation speed of the distance measurement light (TOF (Time Of Fright) method). The distance measurement processing unit 15 notifies this obtained distance Ds to the timing adjustment processing unit 14.

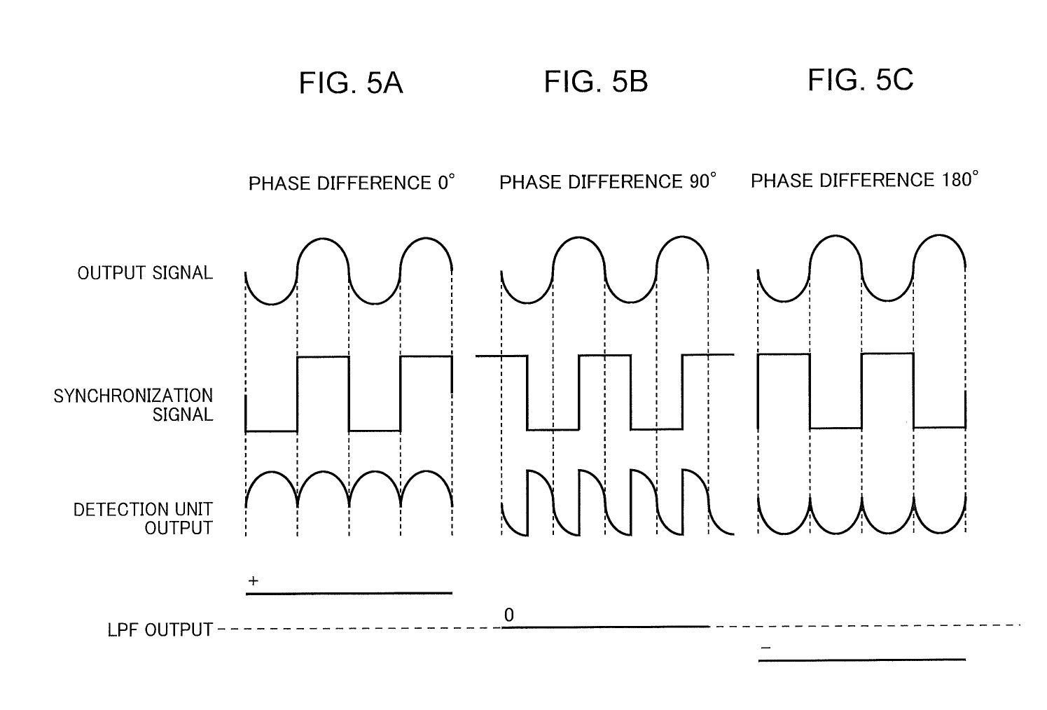

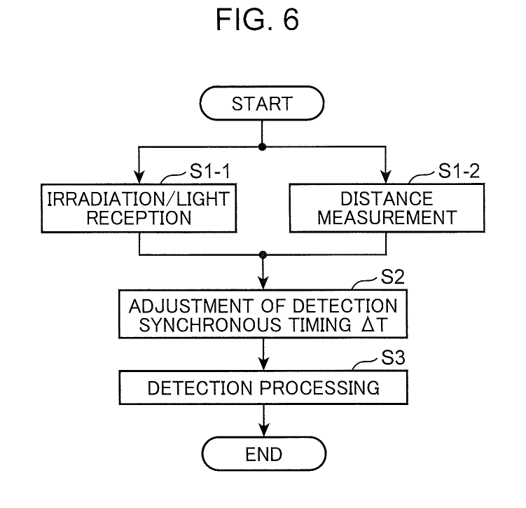

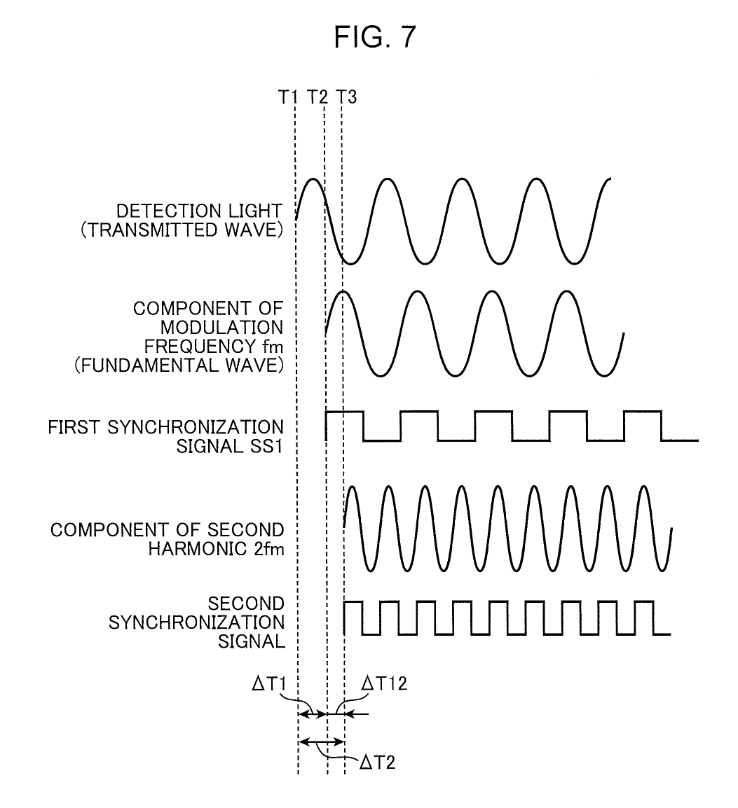

Next, the operation of the gas detection device D is described. FIG. 5 is a graph showing a detection synchronous timing of a synchronization signal in response to an output signal in the first and second phase-sensitive detection units. FIG. 5A shows a case where a phase difference between the output signal and the synchronization signal is 0°, FIG. 5B shows a case where the phase difference between the output signal and the synchronization signal is 90° and FIG. 5C shows a case the phase difference between the output signal and the synchronization signal is 0°. In each of FIGS. 5A to 5C, the output signal, the synchronization signal, a detection unit output and an LPF unit output are respectively shown successively from top to bottom, a horizontal axis represents time and a vertical axis represents a signal level (signal intensity). FIG. 6 is a flow chart showing the operation of the gas detection device in the embodiment. FIG. 7 is a chart showing the adjustment of the detection synchronous timing of the gas detection device in the embodiment. In FIG. 7, the detection light (transmitted wave) Lc, the component of the modulation frequency (fundamental wave) fm, the first synchronization signal SS1, the component of the second harmonic 2fm and the second synchronization signal SS2 are respectively shown successively from top to bottom, a horizontal axis represents time and a vertical axis represents a signal level (signal intensity).

First, the significance of the detection synchronous timing (phase adjustment) in the first and second phase-sensitive detection units 8, 9 is described. In the phase-sensitive detection, the phase-sensitive detection result thereof differs depending on the phase difference between the output signal to be detected and the synchronization signal as shown in FIG. 5. If the phase difference between the output signal and the synchronization signal is 0° (i.e. the output signal and the synchronization signal are synchronized (locked) with each other), the detection unit can properly detect the output signal and a proper output is obtained from the LPF unit as shown in FIG. 5A. On the other hand, for example, if the phase difference between the output signal and the synchronization signal is 90° or 180° (i.e. the output signal and the synchronization signal are not synchronized (locked)), the detection unit cannot properly detect the output signal and a proper output cannot be obtained from the LPF unit as shown in FIGS. 5B and 5C. Thus, in the phase-sensitive detection, the phase of the synchronization signal needs to be adjusted such that the phase difference between the output signal and the synchronization signal becomes 0°. In this embodiment, by controlling each of the first and second phase shift units 24, 34 by the timing adjustment processing unit 14 of the control processing unit 11, the first and second synchronization signals SS1, SS2 are adjusted on the basis of the distance Ds to the object Ob obtained by the distance measurement processing unit 15 such that the first output signal SG1 and the first synchronization signal SS1 are synchronized with each other and the second output signal SG2 and the second synchronization signal SS2 are synchronized with each other.

More specifically, the gas detection device D operates as follows. When being started, the gas detection device D initializes each of necessary parts and starts the operation thereof. By executing the control processing program, the control unit 12, the detection processing unit 13, the timing adjustment processing unit 14 and the distance measurement processing unit 15 are functionally configured in the control processing unit 11. Then, the gas detection device D operates as follows in each of the plurality of directions (plurality of measurement points).

In FIG. 6, the control unit 12 of the control processing unit 11 first drives the deflection unit 17 so that the detection light Lc and the distance measurement light Ld propagate in a measurement direction in the measurement this time. Then, the control unit 12 controls the first light source unit 1 via the first drive unit 3 so that the detection light Lc frequency-modulated at the modulation frequency fm using the center frequency fc as a center is emitted in the form of continuous light, and the first light reception unit 6 receives the first reflected light Lcr of the detection light Lc via the wavelength selection unit 5 and outputs the photoelectrically converted first output signal SG1 of the first light reception unit 6 to each of the first and second phase-sensitive detection units 8, 9 (S1-1). More specifically, the detection light Lc emitted from the first light source unit 1 is incident on the deflection unit 17 and deflected in the measurement direction in the measurement this time by the deflection unit 17 to irradiate the object Ob. The object Ob irradiated with the detection light Lc generates the first reflected light Lcr based on the detection light Lc, for example, by specular reflection, scattered reflection or the like. This first reflected light Lcr is incident on the deflection unit 17, deflected to the wavelength selection unit 5 by the deflection unit 17 and received by the first light reception unit 6 via the wavelength selection unit 5. Then, the first light reception unit 6 outputs the photoelectrically converted first output signal SG1 of the first light reception unit 6 to each of the first and second phase-sensitive detection units 8, 9. Note that the first output signal SG1 includes not only the component of the modulation frequency fm, but also the component of the second harmonic 2fm if the detection target gas GA is present at least in one of the optical path of the detection light Lc and the optical path of the first reflected light Lcr. On the other hand, the control unit 12 controls the second light source unit 2 via the second drive unit 4 so that the distance measurement light Ld is emitted in the form of pulsed light, and the second light reception unit 7 receives the second reflected light Ldr of the distance measurement light Ld via the wavelength selection unit 5 and outputs the photoelectrically converted second output signal SG2 of the second light reception unit 7 to the control processing unit 11 via the amplification unit 10 and the AD unit 18, and the control processing unit 11 obtains the distance Ds to the object Ob by the distance measurement processing unit 15 (S1-2). More specifically, the distance measurement light Ld emitted from the second light source unit 2 is incident on the deflection unit 17 and deflected in the measurement direction in the measurement this time by the deflection unit 17 to irradiate the object Ob. The object Ob irradiated with the distance measurement light Ld generates the second reflected light Ldr based on the distance measurement light Ld, for example, by specular reflection, scattered reflection or the like. This second reflected light Ldr is incident on the deflection unit 17, deflected to the wavelength selection unit 5 by the deflection unit 17 and received by the second light reception unit 7 via the wavelength selection unit 5. The second light reception unit 7 has the photoelectrically converted second output signal SG2 of the second light reception unit 7 amplified by the amplification unit 10 and digitized by the AD unit 18 and outputs the resultant signal to the control processing unit 11. In the control processing unit 11, the distance measurement processing unit 15 obtains the propagation time τ (=t2−t1) until the second reflected light Ldr of the distance measurement light Ld is received by the second light reception unit 7 after the distance measurement light Ld in the form of pulsed light is emitted from the second light source unit 2 by subtracting the irradiation timing t1 from the light reception timing t2, and obtains the distance Ds from the gas detection device D to the object Ob by multiplying half the thus obtained propagation time τ by the propagation speed (speed of light in this embodiment) of the distance measurement light Ld. The distance measurement processing unit 15 notifies this obtained distance Ds to the timing adjustment processing unit 14.

Subsequently, the control processing unit 11 adjusts each of the synchronous detection timings of the first and second phase-sensitive detection units 8, 9 on the basis of the distance Ds to the object Ob obtained by the distance measurement processing unit 15 by the timing adjustment processing unit 14.

Here, the first light reception unit 6 receives the first reflected light Lcr irradiated in the form of continuous light from the gas detection device D, having propagated to the object Ob, having become the first reflected light Lcr at the object Ob and having propagated back to the gas detection device D, and outputs the first output signal SG1. Thus, a timing at which the phase of the component of the modulation frequency fm included in the first output signal SG1 output from the first light reception unit 6 becomes 0° (timing at which an amplitude becomes 0 when changing from negative to positive in the component of the modulation frequency fm) is delayed from a timing at which the phase of the detection light Lc becomes 0° (timing at which the frequency of the frequency-modulated detection light Lc becomes the center frequency fc) by a propagation time ΔT1 for a distance 2Ds reciprocating to and from the object Ob (first delay time ΔT1) as shown in FIG. 7. A timing at which the phase of the component of the second harmonic 2fm included in the first output signal SG1 output from the first light reception unit 6 becomes 0° (timing at which an amplitude becomes 0 in changing from negative to positive in the component of the second harmonic 2fm) is also delayed from the timing at which the phase of the detection light Lc becomes 0° by the propagation time (delay time) ΔT1. In this embodiment, as shown in FIG. 7, an adjustment delay time ΔT12 set in advance in consideration of the influences of a delay in the circuit, a center deviation of the frequency modulation, and the like is added to the propagation time (delay time) ΔT1. Specifically, the timing at which the phase of the component of the second harmonic 2fm included in the first output signal SG1 output from the first light reception unit 6 becomes 0° is adjusted by a second delay time ΔT2=ΔT1+ΔT12.

Accordingly, to synchronously detect the component of the modulation frequency fm included in the first output signal SG1 output from such a first light reception unit 6, the timing adjustment processing unit 14 obtains the first delay time ΔT1 by obtaining the propagation time ΔT1 for the distance 2Ds reciprocating to and from the object Ob from the distance Ds to the object Ob obtained by the distance measurement processing unit 15, and controls the first phase shift unit 24 by outputting a phase adjustment signal for controlling the first phase shift unit 24 to the first phase shift unit 24 so that the first synchronization signal SS1 reaching a phase of 0° (the rise of a pulse) at a timing delayed from the timing at which the phase of the detection light Lc becomes 0° by the first delay time ΔT1 is output to the first detection unit 21. This causes the component of the modulation frequency fm and the first synchronization signal SS1 to synchronize with each other (timing at which the amplitude becomes 0 in changing from negative to positive in the component of the modulation frequency fm=pulse rise timing in the first output signal SG1) in the first phase-sensitive detection unit 8, and the component of the modulation frequency fm included in the first output signal SG1 is detected and output from the first phase-sensitive detection unit 8 to the control processing unit 11. Similarly, to synchronously detect the component of the second harmonic 2fm included in the first output signal SG1 output from such a first light reception unit 6, the timing adjustment processing unit 14 obtains the second delay time ΔT2 (=ΔT1+ΔT12) by obtaining the propagation time ΔT1 for the distance 2Ds reciprocating to and from the object Ob from the distance Ds to the object Ob obtained by the distance measurement processing unit 15, and controls the second phase shift unit 34 by outputting a phase adjustment signal for controlling the second phase shift unit 34 to the second phase shift unit 34 so that the second synchronization signal SS2 reaching a phase of 0° (the rise of a pulse) at a timing delayed from the timing at which the phase of the detection light Lc becomes 0° by the second delay time ΔT2 is output to the second detection unit 31. This causes the component of the second harmonic 2f and the second synchronization signal SS2 to synchronize with each other (timing at which the amplitude becomes 0 in changing from negative to positive in the component of the second harmonic 2f=pulse rise timing in the second output signal SG2) in the second phase-sensitive detection unit 9, and the component of the second harmonic 2fm included in the first output signal SG1 is detected and output from the second phase-sensitive detection unit 9 to the control processing unit 11.

Then, the control processing unit 11 detects the detection target gas GA on the basis of the first reflected light Lcr of the detection light Lc received by the first light reception unit 6 by the detection processing unit 13 and outputs this detection result to another instrument (S3). In this embodiment, the detection processing unit 13 divides the second phase-sensitive detection result (component of the second harmonic 2fm) of the second phase-sensitive detection unit 9 by the first phase-sensitive detection result (component of the modulation frequency fm) of the first phase-sensitive detection unit 8, converts this division result into the concentration thickness product using, for example, the look-up table or the like described above and stored in the storage unit 16 in advance, and detects the detection target gas. Preferably, the detection processing unit 13 may further obtain an average gas concentration by dividing this obtained concentration thickness product by the distance Ds obtained by the distance measurement processing unit 15.

In this way, the operation in the measurement direction in the measurement this time is finished. Such an operation is then performed for each of the plurality of directions.

Note that, as understood from above, the first light source unit 1, the first drive unit 3, the deflection unit 17, the wavelength selection unit 5, the first light reception unit 6, the first and second phase-sensitive detection units 8, 9 and the control processing unit 11 correspond to an example of the gas detection unit, and the second light source unit 2, the second drive unit 4, the deflection unit 17, the wavelength selection unit 5, the second light reception unit 7, the amplification unit 10, the AD unit 18 and the control processing unit 11 correspond to an example of the distance measurement unit.

As described above, since the gas detection device D and the gas detection method implemented in this according to this embodiment actually measure the distance Ds to the object Ob, which is irradiated with the detection light Lc and generates the first reflected light Lcr based on the detection light Lc, using the distance measurement processing unit 15 and the like, even if the object Ob changes (differs) in each detection, the propagation time ΔT1 of the detection light Lc and the first reflected light Lcr can be obtained and the synchronous detection timing based on the propagation time ΔT1 can be obtained. Since the above gas detection device D and gas detection method adjust the synchronous detection timings of the first and second phase-sensitive detection units 8, 9, the gas can be more accurately detected. Since the synchronous detection timings of the first and second phase-sensitive detection units 8, 9 are adjusted as just described, the above gas detection device and gas detection method enable a higher modulation frequency fm and faster detection. Specifically, the above gas detection device and gas detection method are suitable for faster detection. For example, although the modulation frequency fm is conventionally about 10 kHz, the gas detection device D and gas detection method in this embodiment enable the modulation frequency fm to be set higher, for example, to 50 kHz or 100 kHz.

Since the first optical axis of the detection light Lc and the second optical axis of the distance measurement light Ld are parallel to each other in the above gas detection device D and gas detection method, the interference of the detection light Lc and the distance measurement light Ld can be prevented. Thus, the gas can be more accurately detected. Particularly, the first and second optical axes are proximately parallel to each other, more preferably most proximately parallel without overlapping each other, whereby such gas detection device D and gas detection method can precisely measure the distance to the object Ob while preventing mutual interference. Thus, the gas can be more accurately detected.

Since the first light receiving sensitivity wavelength band of the first light reception unit 6 and the second light receiving sensitivity wavelength band of the second light reception unit 7 are different from each other by the predetermined sensitivity threshold value or larger in the above gas detection device D and gas detection method, the reception of the second reflected light Ldr by the first light reception unit 6 can be reduced and the reception of the first reflected light Lcr by the second light reception unit 7 can be reduced. Thus, the above gas detection device D and gas detection method can reduce noise caused by the reception of the second reflected light Ldr by the first light reception unit 6 and noise caused by the reception of the first reflected light Lc by the second light reception unit 7, wherefore the gas can be more accurately detected. Further, because of this, the above gas detection device D and gas detection method have a possibility of being able to omit a filter for reducing the reception of the second reflected light Ldr in the first light reception unit 6 and a filter for reducing the reception of the first reflected light Lcr in the second light reception unit 7 depending on accuracy required for the above gas detection device D and gas detection method.

Since the laser light having a wavelength of 1653 nm, which is an R(3) line, or having a wavelength of 1651 nm, which is an R(4) line, at which methane is most strongly absorbed is used as the detection light Lc in the above gas detection device D and gas detection method, methane can be suitably detected as the detection target gas GA. Further, by setting the wavelength of the detection light Lc at 1653 nm or 1651 nm, an InGaAs light receiving element having light receiving sensitivity to the 1600 nm wavelength band can be used as the first light reception unit 6 in the above gas detection device D and gas detection method.

Since the wavelength of the distance measurement light Ld is set at any one of wavelengths in the wavelength range of 800 nm to 1000 nm in the above gas detection device D and gas detection method, a Si light receiving element having light receiving sensitivity to this wavelength range of 800 nm to 1000 nm can be suitably utilized as the second light reception unit 7.

A system for detecting the detection target gas GA and a system for measuring a distance are independent separate systems in the above gas detection device D and gas detection method.

Note that although the first optical axis of the detection light Lc and the second optical axis of the distance measurement light Ld are proximately parallel to each other in the above embodiment, the first optical axis of the detection light Lc and the second optical axis of the distance measurement light Ld may be substantially coaxial. Specifically, the first and second light source units 1, 2 are so arranged with respect to the deflection unit 17 that the first optical axis of the detection light Lc and the second optical axis of the distance measurement light Ld are substantially coaxial. Since the first and second optical axes are substantially coaxial with each other according to this, such a gas detection device D can reliably measure the distance Ds to the object Ob that generates the reflected light Lcr, wherefore the gas can be more accurately detected.

Further, if the first and second light source units 1, 2 include a semiconductor laser in these embodiments described above, a temperature sensor, a Peltier element or the like may be, for example, provided for stable operation of the semiconductor laser and the semiconductor laser may be temperature-controlled.

Further, in these embodiments described above, the gas detection device D may further include a first band-pass filter for transmitting light in a predetermined wavelength band including the wavelength of the reflected light Lcr of the detection light Lc on an incident side of the first light reception unit 6 to reduce noise. Similarly, the gas detection device D may include a second band-pass filter for transmitting light in a predetermined wavelength band including the wavelength of the reflected light Ldr of the distance measurement light Ld on an incident side of the second light reception unit 7 to reduce noise.

Further, in these embodiments described above, the first and second phase-sensitive detection units 8, 9 may be functionally configured into DSPs (Digital Signal Processors) or the like and the phase-sensitive detection may be performed by a digital signal processing. In this case, the first output signal SG1 of the first light reception unit 6 is input to the DSPs or the like via an analog-digital converter.

This specification discloses various technologies as described above. Out of those, the main technologies are summarized below.

A gas detection device according to one aspect includes a gas detection unit for irradiating detection light (sensing light) frequency-modulated at a predetermined modulation frequency using a predetermined frequency as a center frequency, receiving reflected light of the detection light by an object and detecting detection target gas on the basis of the received reflected light, and a distance measurement unit for measuring a distance to the object, wherein the gas detection unit includes a light reception unit for receiving the reflected light, a phase-sensitive detection unit for performing a phase-sensitive detection of an output signal of the light reception unit and a timing adjustment processing unit for adjusting a synchronous detection timing of the phase-sensitive detection unit on the basis of the distance to the object measured by the distance measurement unit. In terms of detecting the detection target gas by a frequency modulation method (2f detection method), in the above gas detection device, the phase-sensitive detection unit preferably includes a first phase-sensitive detection unit for performing a phase-sensitive detection of the output signal of the light reception unit on the basis of the predetermined modulation frequency and a second phase-sensitive detection unit for performing a phase-sensitive detection of the output signal of the light reception unit on the basis of twice the predetermined modulation frequency, and the timing adjustment processing unit preferably adjusts a synchronous detection timing of each of the first and second phase-sensitive detection units on the basis of the distance to the object measured by the distance measurement unit. In terms of obtaining a concentration thickness product in the detection target gas, in the above gas detection device, the gas detection unit preferably detects the detection target gas by obtaining the concentration thickness product in the detection target gas on the basis of the received reflected light. In terms of utilizing the measurement of the distance by the distance measurement unit, in the above gas detection device, the gas detection unit preferably obtains the concentration thickness product in the detection target gas on the basis of the received reflected light and detects the detection target gas by obtaining an average gas concentration by dividing this obtained concentration thickness product by the distance measured by the distance measurement unit. In terms of detection at a plurality of detection points, the gas detection device preferably further includes a deflection unit for irradiating the detection light in each of a plurality of mutually different directions.

Since such a gas detection device can actually measure the distance to the object by the distance measurement unit, a propagation time of the detection light and the reflected light can be obtained and the synchronous detection timing can be obtained on the basis of the propagation time even if the object changes (differs) in each detection. Since the gas detection device adjusts the synchronous detection timing of the phase-sensitive detection unit to this obtained synchronous detection timing, the gas can be more accurately detected. Since the synchronous detection timing of the phase-sensitive detection unit is adjusted in this way, the above gas detection device enables a higher modulation frequency and faster detection. Specifically, the above gas detection device is suitable for faster detection.

In another aspect, in the above gas detection device, the distance measurement unit includes an optical distance measurement unit for irradiating predetermined distance measurement light having a frequency different from that of the detection light, receiving second reflected light of the distance measurement light by the object and measuring the distance to the object on the basis of an irradiation timing of irradiating the distance measurement light and a light reception timing of receiving the second reflected light of the distance measurement light, and a first optical axis of the detection light in the gas detection unit and a second optical axis of the distance measurement light in the distance measurement unit are substantially coaxial. Preferably, in the above gas detection device, the frequency of the detection light is a frequency of an absorption line in the detection target gas and the frequency of the distance measurement light is a frequency other than the frequency of the absorption line in the detection target gas.

Since the first and second optical axes are substantially coaxial with each other in such a gas detection device, the distance to the object that generates reflected light can be reliably measured, wherefore the gas can be more accurately detected.

In another aspect, in the above gas detection device, the distance measurement unit includes an optical distance measurement unit for irradiating predetermined distance measurement light having a frequency different from that of the detection light, receiving second reflected light of the distance measurement light by the object and measuring the distance to the object on the basis of an irradiation timing of irradiating the distance measurement light and a light reception timing of receiving the second reflected light of the distance measurement light, and a first optical axis of the detection light in the gas detection unit and a second optical axis of the distance measurement light in the distance measurement unit are parallel. In the above gas detection device, the first and second optical axes are preferably proximately parallel to each other, more preferably most proximately parallel without overlapping each other.

Since the first and second optical axes are parallel to each other in such a gas detection device, the interference of the detection light and the distance measurement light can be prevented, wherefore the gas can be more accurately detected.

In another aspect, in these detection devices described above, the distance measurement unit includes an optical distance measurement unit for irradiating predetermined distance measurement light having a frequency different from that of the detection light, receiving second reflected light of the distance measurement light by the object and measuring the distance to the object on the basis of an irradiation timing of irradiating the distance measurement light and a light reception timing of receiving the second reflected light of the distance measurement light, and a light receiving sensitivity wavelength band of the light reception unit in the gas detection unit and a second light receiving sensitivity wavelength band of a second light reception unit for receiving the second reflected light of the distance measurement light in the optical distance measurement unit are different from each other by a predetermined sensitivity threshold value or larger. In terms of suitably receiving light in a 1600 nm wavelength band, the light reception unit in the gas detection unit preferably includes an InGaAs (indium gallium arsenide) light receiving element in the above gas detection device. In terms of suitably receiving light in a wavelength band of 800 nm to 1000 nm, the second light reception unit in the optical distance measurement unit preferably includes a Si (silicone) light receiving element, more preferably includes a Si avalanche photodiode in the above gas detection device.

Since the light receiving sensitivity wavelength band of the light reception unit and the second light receiving sensitivity wavelength band of the second light reception unit are different from each other by the predetermined sensitivity threshold value in such a gas detection device, the reception of the second reflected light by the light reception unit can be reduced and the reception of the reflected light by the second light reception unit can be reduced. Thus, the above gas detection device can reduce noise caused by the reception of the second reflected light by the light reception unit and reduce noise caused by the reception of the reflected light by the second light reception unit, wherefore the gas can be more accurately detected. Further, because of this, the above gas detection device D has a possibility of being able to omit a filter for reducing the reception of the second reflected light in the light reception unit and a filter for reducing the reception of the reflected light in the second light reception unit depending on accuracy required for the above gas detection device.

In another aspect, a wavelength of the detection light in the gas detection unit is 1651 nm or 1653 nm in these gas detection devices described above.

The wavelength of 1651 nm or 1653 nm is an R(4) line or R(3) line at which methane is most strongly absorbed, and the above gas detection device can suitably detect methane as the detection target gas. Further, by setting the wavelength of the detection light at 1651 nm or 1653 nm, an InGaAs light receiving element having light receiving sensitivity to a 1600 nm wavelength band can be suitably utilized as the light reception unit in the gas detection unit in the above gas detection device.

In another aspect, a wavelength of the distance measurement light in the optical distance measurement unit is any one of wavelengths in a wavelength range of 800 nm to 1000 nm in these gas detection devices described above.

By setting the wavelength of the distance measurement light at any one of the wavelengths in the wavelength range of 800 nm to 1000 nm, a Si light receiving element having light receiving sensitivity to this wavelength range of 800 nm to 1000 nm can be suitably utilized as the second light reception unit in the optical distance measurement unit in the above gas detection device.

A gas detection method according to another aspect includes a gas detection step of irradiating detection light frequency-modulated at a predetermined modulation frequency using a predetermined frequency as a center frequency, receiving reflected light of the detection light by an object and detecting detection target gas on the basis of the received reflected light and a distance measurement step of measuring a distance to the object, wherein the gas detection step includes a light reception step of receiving the reflected light by a light reception unit, a phase-sensitive detection step of performing a phase-sensitive detection of an output signal of the light reception unit and a timing adjustment step of adjusting a synchronous detection timing in the phase-sensitive detection step on the basis of the distance to the object measured in the distance measurement step.

Since such a gas detection method actually measures the distance to the object in the distance measurement step, a propagation time of the detection light and the reflected light can be obtained and the synchronous detection timing can be obtained on the basis of the propagation time even if the object changes (differs) in each detection. Since the gas detection method adjusts the synchronous detection timing in the phase-sensitive detection step to this obtained synchronous detection timing, the gas can be more accurately detected. Since the synchronous detection timing in the phase-sensitive detection step is adjusted in this way, the above gas detection method enables a higher modulation frequency and faster detection. Specifically, the above gas detection method is suitable for faster detection.

This application is based on Japanese Patent Application No. 2015-143044 filed on Jul. 17, 2015, and the contents thereof are included in this application.

To express the present invention, the present invention has been appropriately and sufficiently described through the embodiment with reference to the drawings above. However, it should be recognized that those skilled in the art can easily modify and/or improve the embodiment described above. Therefore, it is construed that modifications or improvements made by those skilled in the art are included within the scope of the appended claims unless those modifications or improvements depart from the scope of the appended claims.

### INDUSTRIAL APPLICABILITY

According to the present invention, it is possible to provide a gas detection device and a gas detection method.

1. A gas detection device, comprising:
a gas detector that irradiates detection light frequency-modulated at a predetermined modulation frequency using a predetermined frequency as a center frequency, receives reflected light of the detection light by an object and detects detection target gas on the basis of the received reflected light: and
a distance meter that measures a distance to the object,
wherein the gas detector includes:
a light receiver that receives the reflected light;
a phase-sensitive detector that performs a phase-sensitive detection of an output signal of the light reception unit; and
a timing adjuster that adjusts a synchronous detection timing of the phase-sensitive detection unit on the basis of the distance to the object measured by the distance measurement unit.

2. A gas detection device according to claim 1, wherein:
the distance meter includes an optical distance meter that irradiates predetermined distance measurement light having a frequency different from that of the detection light, receives second reflected light of the distance measurement light by the object and measures the distance to the object on the basis of an irradiation timing of irradiating the distance measurement light and a light reception timing of receiving the second reflected light of the distance measurement light; and
a first optical axis of the detection light in the gas detector and a second optical axis of the distance measurement light in the distance meter are substantially coaxial.

3. A gas detection device according to claim 1, wherein:
the distance meter includes an optical distance meter that irradiates predetermined distance measurement light having a frequency different from that of the detection light, receives second reflected light of the distance measurement light by the object and measures the distance to the object on the basis of an irradiation timing of irradiating the distance measurement light and a light reception timing of receiving the second reflected light of the distance measurement light; and
a first optical axis of the detection light in the gas detector and a second optical axis of the distance measurement light in the distance meter are parallel.

4. A gas detection device according to claim 1, wherein:
the distance meter includes an optical distance meter that irradiates predetermined distance measurement light having a frequency different from that of the detection light, receives reflected light of the distance measurement light by the object and measures a distance to the object on the basis of an irradiation timing of irradiating the distance measurement light and a light reception timing of receiving the second reflected light of the distance measurement light; and
a light receiving sensitivity wavelength band of the light receiver in the gas detector and a second light receiving sensitivity wavelength band of a second light receiver that receives the second reflected light of the distance measurement light in the optical distance meter are different from each other by a predetermined sensitivity threshold value or larger.

5. A gas detection device according to claim 1, wherein a wavelength of the detection light in the gas detector is 1651 nm or 1653 nm.

6. A gas detection device according to claim 2, wherein a wavelength of the distance measurement light in the optical distance meter is any one of wavelengths in a wavelength range of 800 nm to 1000 nm.

7. A gas detection method, comprising:
a gas detection step of irradiating detection light frequency-modulated at a predetermined modulation frequency using a predetermined frequency as a center frequency, receiving reflected light of the detection light by an object and detecting detection target gas on the basis of the received reflected light; and
a distance measurement step of measuring a distance to the object;
wherein the gas detection step includes:
a light reception step of receiving the reflected light by a light reception unit;
a phase-sensitive detection step of performing a phase-sensitive detection of an output signal of the light reception unit; and
a timing adjustment step of adjusting a synchronous detection timing in the phase-sensitive detection step on the basis of the distance to the object measured in the distance measurement step.
